(19) United States
(12) Patent Application Publication
(10) Pub. No.: US 2025/0106836 A1
(43) Pub. Date: Mar. 27, 2025

(54) DYNAMIC SERVING CELL CONFIGURATION

(71) Applicant: Nokia Technologies Oy, Espoo (FI)

(72) Inventors: Tero HENTTONEN, Espoo (FI); Subramanya CHANDRASHEKAR, Bangalore (IN); Amaanat ALI, Espoo (FI); Lars DALSGAARD, Oulu (FI)

(21) Appl. No.: 18/730,851

(22) PCT Filed: Jan. 24, 2022
(86) PCT No.: PCT/EP2022/051439

§ 371 Date: Jul. 22, 2024

(51) Int. Cl. H04W 72/1263; H04W 36/00

(52) U.S. Cl. CPC H04W 72/1263; H04W 36/0072

(57) ABSTRACT

An apparatus may receive, from a source network node, a configuration of a channel bandwidth and a first bandwidth part for receiving data from the source network node, for example during a handover from the source network node to a target network node, and a configuration of a second bandwidth part for receiving data from the target network node. The apparatus may communicate data with the source network node and the target network node with a bandwidth including the first bandwidth part and the second bandwidth part using same protocol stack.

### TECHNICAL FIELD

Various example embodiments generally relate to the field of wireless communications. Some example embodiments relate to configuration of a dynamic serving cell (DCell) for handover.

### BACKGROUND

Various wireless communication systems may be configured as a cellular network comprising multiple cells with respective coverage areas. When a device, such as for example user equipment (UE), loses coverage of a serving cell, a handover may be performed to another cell in order to continue an ongoing communication service, for example a phone call. The handover process may however include various delays and interrupt the flow of the user traffic until the device is able to continue the service at the other cell. Since some traffic types (such as voice) are delay-sensitive, handover procedures may be therefore improved.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments improve handover in a communication network. This and other benefits may be achieved by the features of the independent claims. Further example embodiments are provided in the dependent claims, the description, and the drawings.

According to a first aspect, an apparatus may comprise one or more processors, and memory storing instructions that, when executed by the one or more processors, cause the apparatus to: receive, from a source network node, a configuration of a channel bandwidth and a first bandwidth part for communicating data with the source network node, and a configuration of a second bandwidth part for communicating data with a target network node, wherein the first and second bandwidth parts are not overlapping, and wherein the first and second bandwidth parts are contained within the channel bandwidth; and communicate data simultaneously or time-division multiplexed with the source network node and the target network node with a bandwidth comprising the first bandwidth part and the second bandwidth part using same protocol stack and the channel bandwidth.

According to an example embodiment of the first aspect the instructions, when executed by the one or more processors, further cause the apparatus to: terminate communication of data with the source network node configured with the first bandwidth part; and continue communication of data with the target network node with another bandwidth comprising the second bandwidth part but not comprising the first bandwidth part.

According to an example embodiment of the first aspect the instructions, when executed by the one or more processors, further cause the apparatus to: transmit, to the source network node, an indication of a capability to communicate data with the source network node and the target network nodes with different bandwidth parts.

According to an example embodiment of the first aspect, the configuration of the first bandwidth part and/or the configuration of the second bandwidth part is received in a radio resource control reconfiguration message.

According to an example embodiment of the first aspect, the instructions, when executed by the one or more processors, further cause the apparatus to: transmit, to the source network node, an indication of successful establishment of communication with the target network node at the second bandwidth part.

According to an example embodiment of the first aspect, the instructions, when executed by the one or more processors, further cause the apparatus to: terminate the communication of data with the source network node, in response to receiving, from the source network node and/or the target network node, a request to release the source network node.

According to an example embodiment of the first aspect, the first bandwidth part is adjacent to the second bandwidth part.

According to an example embodiment of the first aspect, the source network node and the target network node are associated with same cell identifier.

According to an example embodiment of the first aspect, the source network node and the target network node share same physical downlink control channel and/or physical downlink shared channel for transmission of the data by the source network node and the target network node.

According to an example embodiment of the first aspect, the source network node and the target network node are associated with different cell identifiers.

According to an example embodiment of the first aspect, the source network node and the target network node are associated with different physical downlink control channels and/or physical downlink shared channels for transmission of the data by the source network node and the target network node.

According to an example embodiment of the first aspect, the source network node and the target network node are configured to transmit different synchronization signal blocks.

According to an example embodiment of the first aspect, the instructions, when executed by the one or more processors, further cause the apparatus to: initiate a handover from the source network node to the target network node, wherein the first bandwidth part is configured for communication of data with the source network node at least during the handover, and wherein the second bandwidth part is configured for communication of data with the target network node at least during the handover.

According to an example embodiment of the first aspect, the instructions, when executed by the one or more processors, further cause the apparatus to: initiate the handover, in response to receiving, from the source network node, a medium access control control element command configured to actuate the handover.

According to an example embodiment of the first aspect, the instructions, when executed by the one or more processors, further cause the apparatus to: perform communication of data to the first network node at the first bandwidth part and to the second network node at the second bandwidth part.

According to a second aspect, a method may comprise: receiving, from a source network node, a configuration of a channel bandwidth and a first bandwidth part for communicating data with the source network node, and a configuration of a second bandwidth part for communicating data with a target network node, wherein the first and second bandwidth parts are not overlapping, and wherein the first and second bandwidth parts are contained within the channel bandwidth; and communicate data simultaneously or time-division multiplexed with the source network node and the target network node with a bandwidth comprising the first bandwidth part and the second bandwidth part using same protocol stack and the channel bandwidth.

According to an example embodiment of the second aspect, the method may further comprise: terminating communication of data with the source network node configured with the first bandwidth part; and continuing communication of data with the target network node with another bandwidth comprising the second bandwidth part but not comprising the first bandwidth part.

According to an example embodiment of the second aspect, the method may further comprise: transmitting, to the source network node, an indication of a capability to communicate data with the source network node and the target network nodes with different bandwidth parts.

According to an example embodiment of the second aspect, the configuration of the first bandwidth part and/or the configuration of the second bandwidth part is received in a radio resource control reconfiguration message.

According to an example embodiment of the second aspect, the method may further comprise: transmitting, to the source network node, an indication of successful establishment of communication with the target network node at the second bandwidth part.

According to an example embodiment of the second aspect, the method may further comprise: terminating the communication of data with the source network node, in response to receiving, from the source network node and/or the target network node, a request to release the source network node.

According to an example embodiment of the second aspect, the first bandwidth part is adjacent to the second bandwidth part.

According to an example embodiment of the second aspect, the source network node and the target network node are associated with same cell identifier.

According to an example embodiment of the second aspect, the source network node and the target network node share same physical downlink control channel and/or physical downlink shared channel for transmission of the data by the source network node and the target network node.

According to an example embodiment of the second aspect, the source network node and the target network node are associated with different cell identifiers.

According to an example embodiment of the second aspect, the source network node and the target network node are associated with different physical downlink control channels and/or physical downlink shared channels for transmission of the data by the source network node and the target network node.

According to an example embodiment of the second aspect, the source network node and the target network node are configured to transmit different synchronization signal blocks.

According to an example embodiment of the second aspect, the method may further comprise: initiating a handover from the source network node to the target network node, wherein the first bandwidth part is configured for communication of data with the source network node at least during the handover, and wherein the second bandwidth part is configured for communication of data with the target network node at least during the handover.

According to an example embodiment of the second aspect, the method may further comprise: initiating the handover, in response to receiving, from the source network node, a medium access control control element command configured to actuate the handover.

According to an example embodiment of the second aspect, the method may further comprise: performing communication of data to the first network node at the first bandwidth part and to the second network node at the second bandwidth part.

According to a third aspect a computer program or a computer program product may comprise instructions for causing an apparatus to perform at least the following: receiving, from a source network node, a configuration of a channel bandwidth and a first bandwidth part for communicating data with the source network node, and a configuration of a second bandwidth part for communicating data with a target network node, wherein the first and second bandwidth parts are not overlapping, and wherein the first and second bandwidth parts are contained within the channel bandwidth; and communicate data simultaneously or time-division multiplexed with the source network node and the target network node with a bandwidth comprising the first bandwidth part and the second bandwidth part using same protocol stack and the channel bandwidth. The computer program may further comprise instructions for causing the apparatus to perform any example embodiment of the method of the second aspect.

According to a fourth aspect an apparatus may comprise: means for receiving, from a source network node, a configuration of a channel bandwidth and a first bandwidth part for communicating data with the source network node, and a configuration of a second bandwidth part for communicating data with a target network node, wherein the first and second bandwidth parts are not overlapping, and wherein the first and second bandwidth parts are contained within the channel bandwidth; and means for communicating data simultaneously or time-division multiplexed with the source network node and the target network node with a bandwidth comprising the first bandwidth part and the second bandwidth part using same protocol stack and the channel bandwidth. The apparatus may further comprise means for performing any example embodiment of the method of the second aspect.

According to a fifth aspect, an apparatus may comprise one or more processors, and memory storing instructions that, when executed by the one or more processors, cause the apparatus to: transmit, by a source network node to a device, a configuration of a channel bandwidth and a first bandwidth part for the device to communicate data with the source network node with a protocol stack, and a configuration of a second bandwidth part for the device to communicate data with a target network node with the same protocol stack, wherein the first and second bandwidth parts are not overlapping, and wherein the first and second bandwidth parts are contained within the channel bandwidth.

According to an example embodiment of the fifth aspect, the instructions, when executed by the one or more processors, further cause the apparatus to: transmit, to the target network node: an indication of the first bandwidth part, and a request to configure, for the device, data communication with the source network node and the target network node with different bandwidth parts.

According to an example embodiment of the fifth aspect, the instructions, when executed by the one or more processors, further cause the apparatus to: transmit the indication of the first bandwidth part and the request to configure data communication with the source network node and the target network node with different bandwidth parts, in response to receiving an indication of a capability of the device to communicate data with the source network node and the target network node with different bandwidth parts.

According to an example embodiment of the fifth aspect, the instructions, when executed by the one or more processors, further cause the apparatus to: receive the configuration of the second bandwidth part from the target network node.

According to an example embodiment of the fifth aspect, the indication of the first bandwidth part and the request to configure data communication with the source network node and the target network node with different bandwidth parts is transmitted during handover preparation, and/or the configuration of the second bandwidth part is received as part of a handover preparation confirmation.

According to an example embodiment of the fifth aspect, the configuration of the first bandwidth part and/or the configuration of the second bandwidth part is transmitted in a radio resource control reconfiguration message.

According to an example embodiment of the fifth aspect, the instructions, when executed by the one or more processors, further cause the apparatus to: transmit, to the device, a request to release the source network node, in response to receiving, from the device, an indication of successful establishment of communication by the device with the target network node at the second bandwidth part, or transmit, to the target network node, an indication to release the source network node, in response to receiving, from the device, the indication of successful establishment of communication by the device with the target network node at the second bandwidth part.

According to an example embodiment of the fifth aspect, the first bandwidth part is adjacent to the second bandwidth part.

According to an example embodiment of the fifth aspect, the source network node and the target network node are associated with same cell identifier.

According to an example embodiment of the fifth aspect, the source network node and the target network node share same physical downlink control channel and/or physical downlink shared channel for transmission of the data to the device.

According to an example embodiment of the fifth aspect, the source network node and the target network node are associated with different cell identifiers.

According to an example embodiment of the fifth aspect, the source network node and the target network node are associated with different physical downlink control channels and/or physical downlink shared channels for transmission of the data to the device.

According to an example embodiment of the fifth aspect, the source network node and the target network node are configured to transmit different synchronization signal blocks.

According to an example embodiment of the fifth aspect, the instructions, when executed by the one or more processors, further cause the apparatus to: transmit, to the device, a medium access control control element command configured to actuate a handover of the device from the source network node to the target network node, wherein the first bandwidth part is configured for communication of data between the device and the source network node at least during the handover, and wherein the second bandwidth part is configured for communication of data between the device and the target network node at least during the handover.

According to an example embodiment of the fifth aspect, the source network node and the target network node are associated with the same access network node or different access network nodes in a disaggregated network architecture.

According to an example embodiment of the fifth aspect, the source network node and the target network node is the same access network node.

According to a sixth aspect, a method may comprise: transmitting, by a source network node to a device, a configuration of a channel bandwidth and a first bandwidth part for the device to communicate data with the source network node with a protocol stack, and a configuration of a second bandwidth part for the device to communicate data with a target network node with the same protocol stack, wherein the first and second bandwidth parts are not overlapping, and wherein the first and second bandwidth parts are contained within the channel bandwidth.

According to an example embodiment of the sixth aspect, the method may further comprise: transmitting, to the target network node: an indication of the first bandwidth part, and a request to configure, for the device, data communication with the source network node and the target network node with different bandwidth parts.

According to an example embodiment of the sixth aspect, the method may further comprise: transmitting the indication of the first bandwidth part and the request to configure data communication with the source network node and the target network node with different bandwidth parts, in response to receiving an indication of a capability of the device to communicate data with the source network node and the target network node with different bandwidth parts.

According to an example embodiment of the sixth aspect, the method may further comprise: receiving the configuration of the second bandwidth part from the target network node.

According to an example embodiment of the sixth aspect, the indication of the first bandwidth part and the request to configure data communication with the source network node and the target network node with different bandwidth parts is transmitted during handover preparation, and/or the configuration of the second bandwidth part is received as part of a handover preparation confirmation.

According to an example embodiment of the sixth aspect, the configuration of the first bandwidth part and/or the configuration of the second bandwidth part is transmitted in a radio resource control reconfiguration message.

According to an example embodiment of the sixth aspect, the method may further comprise: transmitting, to the device, a request to release the source network node, in response to receiving, from the device, an indication of successful establishment of communication by the device with the target network node at the second bandwidth part, or transmitting, to the target network node, an indication to release the source network node, in response to receiving, from the device, the indication of successful establishment of communication by the device with the target network node at the second bandwidth part.

According to an example embodiment of the sixth aspect, the first bandwidth part is adjacent to the second bandwidth part.

According to an example embodiment of the sixth aspect, the source network node and the target network node are associated with same cell identifier.

According to an example embodiment of the sixth aspect, the source network node and the target network node share same physical downlink control channel and/or physical downlink shared channel for transmission of the data to the device.

According to an example embodiment of the sixth aspect, the source network node and the target network node are associated with different cell identifiers.

According to an example embodiment of the sixth aspect, the source network node and the target network node are associated with different physical downlink control channels and/or physical downlink shared channels for transmission of the data to the device.

According to an example embodiment of the sixth aspect, the source network node and the target network node are configured to transmit different synchronization signal blocks.

According to an example embodiment of the sixth aspect, the method may further comprise: transmitting, to the device, a medium access control control element command configured to actuate a handover of the device from the source network node to the target network node, wherein the first bandwidth part is configured for communication of data between the device and the source network node at least during the handover, and wherein the second bandwidth part is configured for communication of data between the device and the target network node at least during the handover.

According to an example embodiment of the sixth aspect, the source network node and the target network node are associated with the same access network node or different access network nodes in a disaggregated network architecture.

According to an example embodiment of the sixth aspect, the source network node and the target network node is the same access network node.

According to a seventh aspect a computer program or a computer program product may comprise instructions for causing an apparatus to perform at least the following: transmitting, by a source network node to a device, a configuration of a channel bandwidth and a first bandwidth part for the device to communicate data with the source network node with a protocol stack, and a configuration of a second bandwidth part for the device to communicate data with a target network node with the same protocol stack, wherein the first and second bandwidth parts are not overlapping, and wherein the first and second bandwidth parts are contained within the channel bandwidth. The computer program may further comprise instructions for causing the apparatus to perform any example embodiment of the method of the sixth aspect.

According to an eighth aspect an apparatus may comprise: means for transmitting, by a source network node to a device, a configuration of a channel bandwidth and a first bandwidth part for the device to communicate data with the source network node with a protocol stack, and a configuration of a second bandwidth part for the device to communicate data with a target network node with the same protocol stack, wherein the first and second bandwidth parts are not overlapping, and wherein the first and second bandwidth parts are contained within the channel bandwidth. The apparatus may further comprise means for performing any example embodiment of the method of the sixth aspect.

According to a ninth aspect, an apparatus may comprise one or more processors, and memory storing instructions that, when executed by the one or more processors, cause the apparatus to: receive, by a target network node from a source network node: an indication of a channel bandwidth and a first bandwidth part configured for communication of data between a device and the source network node, and a request to configure, for the device, data communication with the source network node and the target network node with different bandwidth parts; assign a second bandwidth part for communication of data between the device and the target network node wherein the first and second bandwidth parts are not overlapping, and wherein the first and second bandwidth parts are contained within the channel bandwidth; and transmit, to the source network node, a configuration of the second bandwidth part.

According to an example embodiment of the ninth aspect, the instructions, when executed by the one or more processors, further cause the apparatus to: communicate data with the device using the second bandwidth part.

According to an example embodiment of the ninth aspect, the indication of the first bandwidth part and the request to configure data communication with the source network node and the target network node with different bandwidth parts is included in a handover request, and/or wherein the configuration of the second bandwidth part is included in a handover request acknowledgement message.

According to an example embodiment of the ninth aspect, the instructions, when executed by the one or more processors, further cause the apparatus to: transmit, to the device, a request to release the source network node, in response to receiving, from the source network node, an indication to release the source network node.

According to an example embodiment of the ninth aspect, the first bandwidth part is adjacent to the second bandwidth part.

According to an example embodiment of the ninth aspect, the source network node and the target network node are associated with same cell identifier.

According to an example embodiment of the ninth aspect, the source network node and the target network node share same physical downlink control channel and/or physical downlink shared channel for transmission of the data to the device.

According to an example embodiment of the ninth aspect, the source network node and the target network node are associated with different cell identifiers.

According to an example embodiment of the ninth aspect, the source network node and the target network node are associated with different physical downlink control channels and/or physical downlink shared channels for transmission of the data to the device.

According to an example embodiment of the ninth aspect, the source network node and the target network node are configured to transmit different synchronization signal blocks.

According to a tenth aspect, a method may comprise: receiving, by a target network node from a source network node: an indication of a channel bandwidth and a first bandwidth part configured for communication of data between a device and the source network node, and a request to configure, for the device, data communication with the source network node and the target network node with different bandwidth parts; assigning a second bandwidth part for communication of data between the device and the target network node, wherein the first and second bandwidth parts are not overlapping, and wherein the first and second bandwidth parts are contained within the channel bandwidth; and transmitting, to the source network node, a configuration of the second bandwidth part.

According to an example embodiment of the tenth aspect, the method may further comprise: communicating data with the device using the second bandwidth part.

According to an example embodiment of the tenth aspect, the indication of the first bandwidth part and the request to configure data communication with the source network node and the target network node with different bandwidth parts are included in a handover request, and/or the configuration of the second bandwidth part is included in a handover request acknowledgement message.

According to an example embodiment of the tenth aspect, the method may further comprise: transmitting, to the device, a request to release the source network node, in response to receiving, from the source network node, an indication to release the source network node.

According to an example embodiment of the tenth aspect, the first bandwidth part is adjacent to the second bandwidth part.

According to an example embodiment of the tenth aspect, the source network node and the target network node are associated with same cell identifier.

According to an example embodiment of the tenth aspect, the source network node and the target network node share same physical downlink control channel and/or physical downlink shared channel for transmission of the data to the device.

According to an example embodiment of the tenth aspect, the source network node and the target network node are associated with different cell identifiers.

According to an example embodiment of the tenth aspect, the source network node and the target network node are associated with different physical downlink control channels and/or physical downlink shared channels for transmission of the data to the device.

According to an example embodiment of the tenth aspect, the source network node and the target network node are configured to transmit different synchronization signal blocks.

According to an eleventh seventh aspect a computer program or a computer program product may comprise instructions for causing an apparatus to perform at least the following: receiving, by a target network node from a source network node: an indication of a channel bandwidth and a first bandwidth part configured for communication of data between a device and the source network node, and a request to configure, for the device, data communication with the source network node and the target network node with different bandwidth parts; assigning a second bandwidth part for communication of data between the device and the target network node, wherein the first and second bandwidth parts are not overlapping, and wherein the first and second bandwidth parts are contained within the channel bandwidth; and transmitting, to the source network node, a configuration of the second bandwidth part. The computer program may further comprise instructions for causing the apparatus to perform any example embodiment of the method of the tenth aspect.

According to a twelfth aspect an apparatus may comprise: means for receiving, by a target network node from a source network node: an indication of a channel bandwidth and a first bandwidth part configured for communication of data between a device and the source network node, and a request to configure, for the device, data communication with the source network node and the target network node with different bandwidth parts; means for assigning a second bandwidth part for communication of data between the device and the target network node, wherein the first and second bandwidth parts are not overlapping, and wherein the first and second bandwidth parts are contained within the channel bandwidth; and means for transmitting, to the source network node, a configuration of the second bandwidth part. The apparatus may further comprise means for performing any example embodiment of the method of the tenth aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication network;

FIG. 2 illustrates an example of an apparatus configured to practice one or more example embodiments;

FIG. 3 illustrates an example of dynamic serving cell configuration;

FIG. 4 illustrates an example of a signaling diagram for configuration of dynamic serving cell operation;

FIG. 5 illustrates an example of dynamic serving cell operation in an intra-cell scenario;

FIG. 6 illustrates an example of dynamic serving cell operation in an inter-cell scenario;

FIG. 7 illustrates an example of a method for performing handover;

FIG. 8 illustrates an example of a method for configuring handover at a source network node; and

FIG. 9 illustrates an example of a method for configuring a handover at a target network node.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Need for performing handovers may depend on configuration and structure of the communication network. For example, cells operating at higher carrier frequencies may have smaller coverage area than cells operating at lower frequencies. Additionally, for operation at higher carrier frequencies both UEs and access points may use directional antennas and beamforming, for example in order to ensure sufficient link budget for achieving intended cell coverage and to provide more efficient data transmission.

In 3GPP (3^{rd} Generation Partnership Project) standards, a primary cell (PCell) may serve as an anchor for a RRC (radio resource control) connection between a UE and the network. Changing the primary cell may require performing a handover procedure, which may also involve changing the security key used in communications between the UE and the network. Secondary cells (Scell) may be changed slightly more dynamically, for example by releasing a previous SCell and adding a new SCell, without affecting the UE (RRC) connection and in most cases not interrupting the data on the PCell and the active SCell(s). This may however come with the price of having to activate the SCell again, which may cost some time. Handover may also cause an interruption in the user plane (UP) data service, which may be undesirable, for example for delay-sensitive applications. Various mechanisms may be applied to address this issue, for example soft handover, dual-active protocol stack (DAPS), random access channel-less (RACH-less) handover, or the like. Such solutions however have their own drawbacks.

Additionally, while strict co-location conditions for baseline UEs may be assumed for carrier aggregation (CA)—for example at higher carrier frequencies—coming to the market are high-end devices which may not require similar strict network timing requirements. However, such UEs may only form part of the full device population. Mobility, e.g. moving from coverage of one cell (source cell) to another (target cell), may be due to physical movement of the UE, or, especially at higher carrier frequencies, due to changes in the environment such that another cell becomes better than the current cell. Often this means mobility between non-co-located access points.

Bandwidth adaptation (BA) enables the receive and transmit bandwidth of a UE to be adjusted dynamically. For example, the receive bandwidth may be narrower than the bandwidth of the cell. The bandwidth may be configured change (e.g. to shrink during period of low activity to save power). The location of the active band may also move in the frequency domain (e.g. to increase scheduling flexibility). Also, the subcarrier spacing may be configured to change (e.g. to allow different services). A subset of the total cell bandwidth of a cell may be referred to as a bandwidth part (BWP). Bandwidth adaptation may be achieved by configuring the UE with one or more BWPs and indicating the UE which of the configured BWPs is/are currently active. This enables the network to quickly switch the used amount of resources in a given cell.

Different handover requirements may be defined for different cases, covering for example the following: NR FR1 to NR FR1 handover, NR FR1 to NR FR2 handover, NR FR2 to NR FR2 handover, and NR FR2 to NR FR1 handover, where “NR” refers to the 3GPP 5G New Radio (NR) standard, and FR1 and FR2 refer to Frequency Ranges 1 and 2 defined therein. Handover to other radio access technologies (RAT) may be also defined, as well as dual active protocol stack (DAPS) handover delay requirements, which may be defined in addition to a conditional handover (CHO) procedure.

A DAPS handover procedure may comprise following steps of operations between a UE, a source node (e.g. a 5^{th} generation access point, gNB) of a source cell, and a target node (e.g. another gNB) of a target cell:
1) UE may send a measurement report to a source node (e.g. gNB). The measurement report may comprise information about available neighbouring cell(s).
2) The source node may send a (DAPS) handover request to a target node.
3) The target node may perform DAPS admission control.
4) The target node may transmit a handover request acknowledgement, which may comprise DAPS configuration data.
5) The source node may transmit RRC reconfiguration message to the UE. The RRC reconfiguration message may comprise the DAPS configuration data.
6) User data may be exchanged between the UE and the source node.
7) The source node may forward data received from the UE to the target node.
8) The UE may begin DAPS operation.
9) The UE may exchange data with the source node.
10) The UE may transmit a random access preamble (e.g. on PRACH) to the target node.
11) The target node may transmit a RACH response to the UE.
12) The UE may transmit a RRC reconfiguration complete message to the target node.
13) The target node may transmit a handover success message to the source node.
14) The source node may stop communicating data with the UE.
15) The source node may transmit a serial number (SN) status transfer message to the target node.
16) The target node may transmit a RRC reconfiguration message (source protocol stack release).
17) The UE may perform release source configuration.
18) The UE may transmit a RRC reconfiguration complete message to the target node.
19) User data may be exchanged between the UE and the target node.

Hence, during DAPS handover execution, the UE may communicate with the source and target cells (PCells). RRC reconfiguration may be performed to release the source protocol stack in Step 16 followed by the UE releasing in Step 17. The DAPS feature may mandate the UE to instantiate a dual protocol stack (one protocol stack at the source and the second one at the target) which implies a higher capability requirement from the UE perspective.

A conditional handover (CHO) procedure may comprise following steps of operations between a UE, a source node, a target node, and core network functions AMF (access and mobility management function) and UPF(s) (user plane function):

Initially user data may be exchanged between the UE, the source node and the UPF(s).
0) Mobility control information may be provided by the AMF to the source and target nodes.
1) The UE may perform handover measurements as controlled by the source node.
2) The source node may make a handover decision.
3) The source node may transmit a handover request to the target node. 4) The target node may perform admission control.
5) The target node may transmit a handover request acknowledge message. This step may complete a handover preparation phase comprising the preceding steps.
6) The UE and the source node may perform RAN (radio access network) handover initiation. The source node may then deliver buffered data and new data from the UPF(s). The UE may detach from old cell (source node) and synchronize to new cell (target node).
7) The source node may transmit a SN status transfer message to the target node. This step may be preceded by an early status transfer, which may be referred to as step 7a. UPF(s) may provide user data to the source node, which may forward the user data to the target node. The target node may buffer the user data received from the source node.
8) The UE, the source node, and the target node may complete the RAN handover. This step may complete a handover execution phase comprising Steps 6 to 8.
8a) The target node may transmit a handover success message to the source node.
8b) The source node may transmit a SN status transfer message to the target node. The UPF(s) may then provide user data to the source node, which may forward the user data to the target node. Subsequently, user data may be exchanged between the source node and the target node. The target node may forward user data received from the UE to the UPF(s).
9) The target node may transmit a path switch request to the AMF.
10) The AMF and the UPF(s) may perform path switch in the UPF(s). The UPF(s) may transmit an end marker to the source node, which may forward the end marker to the target node. User data may be then delivered between the target node and the UPF(s).
11) The AMF may transmit a path switch request acknowledge message to the target node.
12) The target node may transmit a UE context release message to the source node.

The conditional handover may comprise a handover that is executed by the UE when one or more handover execution conditions are met. The UE may start evaluating the execution condition(s) upon receiving a conditional handover configuration. The UE may stop evaluating the execution condition(s) once a handover, e.g. a normal (unconditional or baseline) handover or a conditional handover, has been executed. The following principles may apply to conditional handover:
The conditional handover configuration may contain the configuration of conditional handover candidate cell(s) generated by candidate gNB(s) and execution condition(s) generated by the source gNB.
An execution condition may comprise one or more trigger condition(s) (e.g. conditional handover events A3/A5 of 3GPP standards). A single reference signal type may be supported and for example two different trigger quantities, e.g. reference signal received power (RSRP) and reference signal received quality (RSRQ), or, RSRP and signal-to-interference-and-noise ratio (SINR), may be configured simultaneously for the evaluation of conditional handover execution condition of a single candidate cell.
Before any conditional handover execution condition is satisfied, upon reception of a handover command (without conditional handover configuration), the UE may execute a default handover procedure, regardless of any previously received conditional handover configuration.
While executing conditional handover, i.e. from the time when the UE starts synchronization with target cell, UE may not monitor the source cell. Conditional handover therefore enables execution of a preconfigured handover upon satisfaction of preconfigured execution conditions.

Handover delay requirements may include the following delays: when UE receives a RRC message implying handover, the UE shall be ready to start transmission on the new uplink physical random access channel (PRACH) within D_{handover} ms from the end of the last transmission time interval (TTI) containing the RRC command. Parameter D_{handover} may be determined based on a sum of a preconfigured (e.g. standard-defined) RRC procedure delay and an interruption time (Tᵢₙₜₑᵣᵣᵤₚₜ). The interruption time may differ depending on the type of the handover, but it may generally contain one or more of the following delays (terms of the sum).

$${T}_{i n t e r r u p t} = {T}_{s e a r c h} + {T}_{IU} + {T}_{p r o c e s s i n g} + {T}_{Δ} + {T}_{m a r g i n} ( ms )$$

where
T_{search} is a time required to search the target cell when the target cell is not already known when the handover command is received by the UE,
T_{IU} is an interruption uncertainty time in acquiring the first available PRACH occasion in the new cell,
T_{Δ} is a time for fine time tracking and acquiring full timing information of the target cell (T_{Δ}=Tᵣₛ, which corresponds to the SSB periodicity of the target cell and represents the uncertainty for UE being able to measure the cell),
T_{processing} is a time for UE processing, having for example a values up to ms or 40 ms, and
T_{margin} is a time for synchronization signal block (SSB) post-processing, having for example values up to 2 ms.

When intra-frequency or inter-frequency handover is commanded, the interruption time may be required to be less than Tᵢₙₜₑᵣᵣᵤₚₜ.

More efficient handover may be achieved for example by reducing the UE-side handover delay, thereby affecting also the overall handover delay. The overall delay of conditional handover may be slightly different from normal handover. However, conditional handover may still include a period of time where the UE is not required to transmit or receive—corresponding to Tᵢₙₜₑᵣᵣᵤₚₜ, which may be defined for conditional handover as follows: the interruption time is the time between when the UE starts to execute the conditional handover to the target cell and the time the UE starts transmission of the PRACH of the new cell. For intra-frequency or inter-frequency conditional handover, the measurement time may be required to be less than

$${T}_{i n t e r r u p t} = {T}_{p r o c e s s i n g} + {T}_{IU} + {T}_{Δ} + {T}_{m a r g i n} ( ms )$$

As can be seen, Tᵢₙₜₑᵣᵣᵤₚₜ is similar to normal handover except for the absence of the search time (T_{search}), which may be assumed to be non-existing (0 ms) and hence removed.

Delay requirements may be defined also for a DAPS handover. Even though the requirements were slightly different compared to normal and conditional handovers, there may be also further conditions for a DAPS handover. These requirements may be applicable to DAPS handover, for example to change a NR PCell to another NR cell. The requirements may however apply only if
the UE indicates ‘no-gap’ via intraFreq-needForGap parameter for intra-frequency measurement of source cell and intra-frequency measurement of target cell, or
the SSB of source cell is completely contained in the active downlink (DL) bandwidth part (BWP) of the source cell, and the SSB of target cell is completely contained in the active DL BWP of the target cell, or
the initial DL and uplink (UL) BWP of source cell is confined within the active DL and UL BWP of the source cell respectively, and the initial DL and UL BWP of target cell is confined within the active DL and UL BWP of the target cell, respectively.

Therefore, the above handover types may be associated with significant delays and interruptions, which may not be tolerable in all applications. Example embodiments of the present disclosure generally relate to handovers in communication networks. The example embodiments provide a dynamic serving cell concept that enables to reduce the handover delay.

According to an example embodiment, an apparatus may receive, from a source network node, a configuration of a channel bandwidth and a first bandwidth part for communicating data simultaneously or time-division multiplexed with the source network node, for example during a handover from the source network node to a target network node, and a configuration of a second bandwidth part for communicating data with the target network node, for example during the handover. The apparatus may communicate with, e.g. transmit data to and/or receive data from, the source network node and the target network node during the handover with a bandwidth comprising the first bandwidth part and the second bandwidth part. The data transmission and reception may be simultaneous or time-divided according to a pattern, e.g. time-division multiplexed so that the apparatus only transmits to one network node at a time, but such that the apparatus transmits to each network node more than one time. This enables simultaneous or effectively simultaneous data communication with both network nodes during the handover using a single receive bandwidth, thereby enabling an efficient handover without any interruption of data communication.

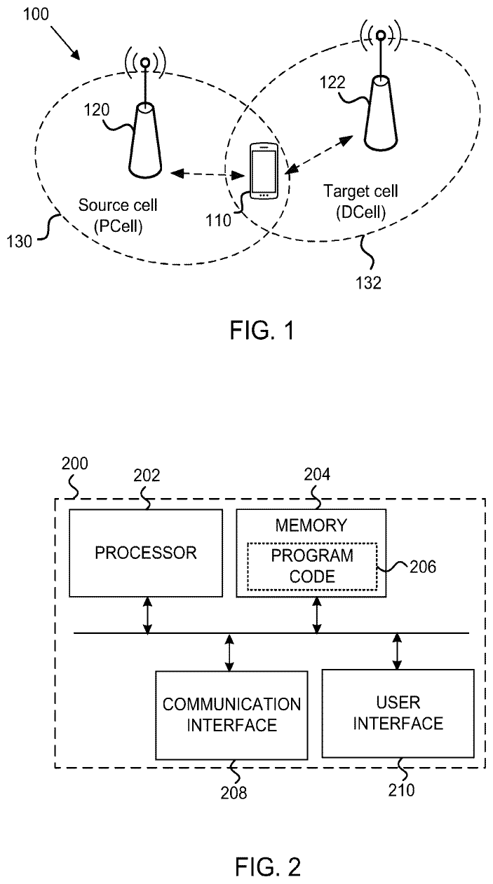

FIG. 1 illustrates an example of a communication network. Communication network 100 may comprise one or more devices, which may be also referred to as client nodes, user nodes, or user equipment (UE). An example of a device is UE 110, which may communicate with one or more access nodes or access points, represented in this example by a 5^{th} generation access nodes (gNB), over wireless radio channel(s). The gNBs may operate as transmission-reception points (TRP). Communications between UE 110 and gNBs 120, 122 may be bidirectional and hence any of these entities may be configured to operate as a transmitter and/or a receiver.

In context of a handover, an access node of a source cell 130 may be called a source access node, a source access point, or a source network node. An access node of a target cell 132 may be called a target access node, a target access point, or a target network node. In various examples of the present disclosure, these network nodes are represented by source gNB 120 and target gNB 122, respectively. An access node may be associated with a cell, which may correspond to a geographical area covered by the access node. For example, source gNB 120 may provide communication services to UE 110 within the source cell 130. Source cell 130 may be a primary cell (PCell), however, from the handover point-of view it acts in this example as a source cell, from which UE 110 is about to be handed over to another cell, in this example target cell 132. Target cell 132 may be configured as a dynamic serving cell (DCell), enabling simultaneous connection to both cells with different bandwidth parts, as will be further described below.

A cell may apply beamforming such that different UEs are served by different beams. For example, source gNB 120 may serve UE 110 with one beam and another UE with another beam. In general, one or more UEs may be served by a beam. In beamforming multiple antenna elements may be configured to transmit the same signal. The signals may be configured to be combined in the air such that the composite signal is reinforced at a specific direction towards the targeted UE(s). This not only enables the signal transmitted by source gNB 120 to be directed to a particular UE, but it also improves reception of signals from this UE. For example, interference from UEs located at other directions may be avoided or reduced. Transmissions from a device to an access node, e.g. from UE 110 to gNB 120 may be referred to as uplink transmissions. Transmissions from an access node to a device may be referred to as downlink transmissions.

Communication network 100 may further comprise one or more core network elements (not shown), for example network nodes, network devices, or network functions. The core network may for example comprise an access and mobility management function (AMF) and/or user plane function (UPF), which enable gNBs 120, 122 to provide various communication services for UE 110. The gNB 120 may be configured to communicate with the core network elements over a communication interface, such as for example a control plane interface and/or a user plane interface (e.g. NG-C/U). Access nodes, such as gNBs 120, 122, may be also called base stations or a radio access network (RAN) nodes and they may be part of a RAN between the core network and UE 110. Functionality of an access node may be distributed between a central unit (CU), for example a gNB-CU, and one or more distributed units (DU), for example gNB-DUs. This scenario may be referred to as a disaggregated network architecture. It is therefore appreciated that access node functionality described herein may be implemented at a gNB, or divided between a gNB-CU and a gNB. Network elements such gNB, gNB-CU, and gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

Communication network 100 may be configured for example in accordance with the 5^{th} generation (5G) digital cellular communication network, as defined by the 3rd Generation Partnership Project (3GPP). In one example, the communication network 100 may operate according to 3GPP 5G NR (New Radio). It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

Data communication in communication network 100 may be based on a protocol stack comprising various communication protocols and layers. Layers of the protocol stack may be configured to provide certain functionalities, for example based on the Open Systems Interconnection (OSI) model or a layer model of a particular standard, such as for example NR.

In one example, the protocol stack may comprise a service data adaptation protocol (SDAP) layer, which may, at the transmitter side, receive data from an application layer for transmission, for example one or more data packets. The SDAP layer may be configured to exchange data with a PDCP (packet data convergence protocol) layer. The PDCP layer may be responsible of generation of PDCP data packets, for example based on data obtained from the SDAP layer.

A radio resource control (RRC) layer, provided for example on top of the PDCP layer, may be configured to implement control plane functionality. RRC may refer to provision of radio resource related control data. RRC messages may be transmitted on various logical control channels such as for example a common control channel (CCCH) or a dedicated control channel (DCCH).

The PDCP layer may provide data to one or more instances of a radio link control (RLC) layer. For example, the PDCP data packets may be transmitted on one or more RLC transmission legs. RLC instance(s) may be associated with corresponding medium access control (MAC) instances of the MAC layer. The MAC layer may deliver the data to the physical layer for transmission.

The MAC layer may provide a mapping between logical channels of the upper layer(s) and transport channels, such as for example broadcast channel (BCH), paging channel (PCH), downlink shared channel (DL-SCH), uplink shared channel (UL-SCH), or random access channel (RACH). The MAC layer may be further configured to handle multiplexing and demultiplexing of MAC service data units (SDU). Furthermore, the MAC layer may provide error correction functionality based on packet retransmissions, for example according to the hybrid automatic repeat request (HARQ) process. The MAC layer may also carry control information, for example in MAC control elements (CE). This enables fast exchange of control information at the MAC layer without involving the upper layers.

The physical layer may provide data transmission services on physical layer channels such as for example the physical broadcast channel (PBCH), physical downlink control channel (PDCCH), physical downlink shared channel (PDSCH), physical uplink control channel (PUCCH), physical uplink shared channel (PUSCH), or physical random access channel (PRACH). The physical layer may for example perform modulation, forward error correction (FEC) coding, define a physical layer frame structure, etc., to transmit upper layer data at the physical channels. The physical channels may carry the transport channels. The physical layer may also carry signalling information, for example downlink control information (DCI). DCI may be carried for example on PDCCH. DCI may include information about uplink resource allocation and/or information about downlink transmissions targeted for UE 110. DCI may be used by gNB 120 for example to schedule an uplink grant for UE 110, i.e., to inform ULE 110 about transmission resources (e.g. subcarriers of particular orthogonal frequency division multiplexing (OFDM) symbols) assigned to UE 110 for uplink transmission. DCI may further indicate the transmission parameters to be used for the uplink grant.

Transmission resources of the physical layer may comprise time and/or frequency resources. An example of a frequency resource is a subcarrier of an orthogonal frequency division multiplexing (OFDM) symbol. An example of a time resource is the OFDM symbol. A resource element (RE) may for example comprise one subcarrier position during one OFDM symbol. A resource element may be configured to carry one modulation symbol, for example a quadrature amplitude modulation (QAM) symbol comprising a real and/or an imaginary parts of the modulation symbol. Transmission resources may be assigned in blocks of resource elements. A resource block may comprise a group of resource elements (e.g. 12 REs). Modulation order may refer to the number of bits carried by one modulation symbol. A bandwidth part may comprise a set of subcarriers.

The protocol stack may therefore comprise the following layers (lowest to highest): physical layer, MAC layer, RLC layer, and PDCP layer. RRC and SDAP protocols may be configured to operate on top of the PDCP layer. The physical layer may be also referred to as Layer 1 (L1). The SDAP, PDCP, RLC, and MAC layers may be collectively referred to as Layer 2 (L2), including the mentioned protocols as sublayers of L2. Corresponding protocol stacks may be applied at UE 110 and gNBs 120, 122. Even though various operations have been described using the above protocol stack as an example, it is appreciated that the described example embodiments may be also applied to other protocol stacks having sufficiently similar functionality.

Example embodiments of the present disclosure may relate to an efficient handover between cells or TRPs. For example, a first scenario relates to an inter-cell multi-TRP like model, where the UE 110 may change a cell without changing the serving cell. A second scenario relates to an inter-cell handover-like model involving a cell change.

When the example embodiments are applied in the inter-cell multi-TRP like scenario, the example embodiments enable enhancement on support for various multi-TRP deployment related aspects (targeting e.g. both FR1 and FR2), for example as follows:
improvement of reliability and robustness for channels other than PDSCH (e.g., PDCCH, PUSCH, and PUCCH) using multi-TRP and/or multi-panel configurations;
enabling inter-cell multi-TRP operations, assuming multi-DCI based multi-PDSCH reception;
beam-management-related enhancements for simultaneous multi-TRP transmission with multi-panel reception;
support for high-speed train single frequency network (HST-SFN) deployment scenario: e.g. by providing solution(s) on quasi co-location (QCL) assumption for demodulation reference signals (DMRS) (e.g. multiple QCL assumptions for the same DMRS port(s)) targeting downlink-only transmission; and/or by providing QCL/QCL-like relation (including applicable type(s) and associated requirement(s)) between downlink and uplink signals by reusing the unified transmission configuration indicator (TCI) framework.

When the example embodiments are applied in the inter-cell handover-like scenario, the example embodiments enable enhancement on multi-beam operation, targeting for example FR2 while being also applicable to FR1, for example as follows:
providing features to facilitate more efficient (e.g. lower latency and/or overhead) downlink/uplink beam management to support higher intra- and L1/L2-centric inter-cell mobility and/or a larger number of configured TCI states: e.g. common beam for data and control transmission or reception for downlink and uplink, for example for intra-band carrier aggregation, and/or a unified TCI framework for downlink and uplink beam indication, and/or enhancement(s) on signaling mechanisms for the above features, for example to improve latency and/or efficiency with more usage of dynamic control signaling (e.g. in contrast to RRC)
providing features to facilitate uplink beam selection for UEs equipped with multiple antenna panels, considering uplink coverage loss mitigation due to maximum permissible exposure (MPE) requirements, based on uplink beam indication with the unified TCI framework for uplink fast panel selection.

In case of inter-cell multi-TRP-like model, the following operations may be performed: 1) A UE may receive from a serving cell, configuration of SSBs of the TRP with different physical cell identifier (PCI) for beam measurement, and configurations needed to use radio resources for data transmission/reception, including resources for different PCI. 2) The UE may perform beam measurement for the TRP with the different PCI and report the measurement results to the serving cell. 3) Based on the report(s), TCI state(s) associated to the TRP with the different PCI may be activated from the serving cell, for example by L1/L2 signaling. 4) The UE may receive and transmit data using a UE-dedicated channel on the TRP with the different PCI. 5) The UE may be in coverage of the serving cell, also for the multi-TRP case, e.g. the UE may use common channels, e.g. BCCH, PCH, or the like, from the serving cell.

In case of an L1L2 mobility model (with serving cell change), the following operations may be performed: 1) The UE may receive from the serving cell, configuration of SSBs of the cell with the different PCI for beam measurement or serving cell change. 2) The UE may perform beam measurement for the cell with the different PCI and report the measurement results to the serving cell. 3) Serving cell configuration for the cell with the different PCI may be provided to the UE, for example by RRC signaling (pre-configuration for serving cell change). 4) Based on the above reports, TCI states for the cell with the different PCI may be activated along with the serving cell change (e.g. by L1/L2 signaling). 5) The UE may change the serving cell and start receiving/transmitting using the pre-configured UE-dedicated channel and TCI states.

The L1L2 mobility may be based on L1 measurements. The L1L2 mobility model may include PCell mobility and optionally also secondary cell (Scell) mobility. For both the multi-TRP and mobility scenarios, a single protocol stack may be used (intra-DU). At least TCI state information may be required for the TRP with the different PCI. Furthermore, different RRC models may be considered, including, but not limited to: cell, BWP, beam resource (e.g. TCI state, QCL-info). It is however noted that the example embodiments of the present disclosure may be generally exploited to improve efficiency of handover in any suitable scenario.

FIG. 2 illustrates an example embodiment of an apparatus 200, for example UE 110, source gNB 120, target gNB 122, or a component or a chipset of UE 110, source gNB 120, or target gNB 122. Apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable apparatus 200 to transmit and/or receive information to/from other devices. In one example, apparatus 200 may use communication interface 208 to transmit or receive signaling information and/or data in accordance with at least one cellular communication protocol. Communication interface 208 may be configured to provide at least one wireless radio connection, such as for example a 3GPP mobile broadband connection (e.g. 3G, 4G, 5G, 6G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface 208 may comprise, or be configured to be coupled to, an antenna or a plurality of antennas to transmit and/or receive radio frequency signals. One or more of the various types of connections may be also implemented as separate communication interfaces, which may be coupled or configured to be coupled to an antenna or a plurality of antennas.

Apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When apparatus 200 is configured to implement some functionality, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as for example software components. According to an embodiment, the apparatus comprises a processor or processor circuitry, such as for example a microcontroller, configured by the program code when executed to execute the embodiments of the operations and functionality described. A computer program or a computer program product may therefore comprise instructions for causing, when executed, apparatus 200 to perform the method(s) described herein. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 comprises means for performing at least one method described herein. In one example, the means comprises the at least one processor 202, the at least one memory 204 including program code 206 configured to, when executed by the at least one processor, cause the apparatus 200 to perform the method. Apparatus 200 may for example comprise means for generating, transmitting, and/or receiving wireless communication signals, for example modulation circuitry, demodulation circuitry, radio frequency (RF) circuitry, or the like. The circuitry(ies) may be coupled to, or configured to be coupled to, one or more antennas to transmit and/or receive the wireless communication signals over an air interface.

Apparatus 200 may comprise a computing device such as for example an access point, a base station, a mobile phone, a smartphone, a tablet computer, a laptop, an internet of things (IoT) device, or the like. Examples of IoT devices include, but are not limited to, consumer electronics, wearables, sensors, and smart home appliances. In one example, apparatus 200 may comprise a vehicle such as for example a car. Although apparatus 200 is illustrated as a single device it is appreciated that, wherever applicable, functions of apparatus 200 may be distributed to a plurality of devices, for example to implement example embodiments as a cloud computing service.

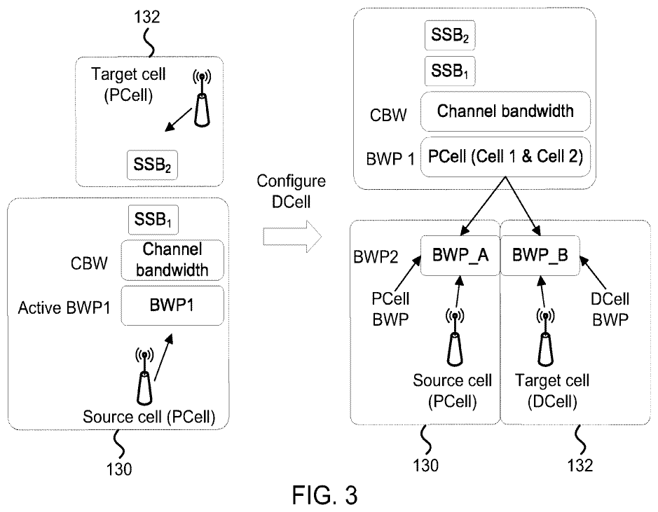

FIG. 3 illustrates an example of dynamic serving cell (DCell) configuration. The serving cell concept may be made “dynamic” by using bandwidth parts of source cell 130 together with bandwidth parts of target cell 132. For example, the network may request UE 110 to link the BWPs from source cell 130 and target cell 132 under one channel bandwidth. This enables UE 110 to transmit data to and/or receive data from both cells using the one channel bandwidth. The data transmission and reception may be simultaneous or time-divided according to a pattern so that UE only transmits to one network node at a time. UE 110 may therefore retain connection to the source cell 130 while accessing the target cell 132. Once the connection to the target cell 132 has been established, the source cell 130 can be released (either autonomously by UE 110 or via a network command) without affecting the target cell connection. This effectively splits the UE bandwidth into two parts: one for source cell 130 and one for target cell 132. The cells may still utilize different PCIs and SSBs, but the frequency domain may be split into two parts to enable concurrent operation, as depicted in FIG. 3.

Initially the source cell 130 may be configured as primary cell (PCell) and the target cell is configured for UE measurements as a candidate PCell. This configuration is illustrated on the left. One active bandwidth part (BWP 1) may be configured for source cell 130 and the channel bandwidth (CBW) contains the entire bandwidth of BWP 1. A first SSB (SSB₁) may be transmitted at source cell 130. A second SSB (SSB₂) may be transmitted at target cell 132. The first and second SSBs may overlap in frequency such that UE 110 is able to receive them at same frequency resources (e.g. subcarriers).

After configuration of target cell 132 as a DCell, source cell 130 (PCell) and target cell 132 (DCell) may be associated with different bandwidth parts BWP_A and BWP_B, respectively, as illustrated on the right. The channel bandwidth (CBW) covers both of these bandwidth parts. Both bandwidth parts may be therefore received by UE 110 with a single receive bandwidth. PCell Cell 1 and Cell 2 may refer to individual PCells that are aggregated under one channel bandwidth. This means that PCell BWP may be a subset of PCell Cell 1 (source PCell) and DCell BWP may be a subset of PCell Cell 2 (target PCell). BWP1 may contain both BWP_A and BWP_B. The existing BWP may be therefore split to allow UE 110 to receive both cells using the same RF bandwidth (CBW). Hence, CBW may contain 1) BWP 1 and 2) BWP_A+BWP_B so that change from using BWP 1 to BWP_A+BWP_B does not require RF retuning. BWP 2 may comprise BWP_A, whereas the “DCell BWP” may contain at least contain BWP_B, but could also be the BWP after switching only to the target cell 130 Source cell 130 and target cell 132 may transmit different SSBs (SSB₁ and SSB₂).

For intra-frequency cases, this configuration enables UE 110 to still receive the same RF (radio frequency) bandwidth (channel bandwidth). However, decoding of the received signals may be done in two logical parts (i.e. BWP/Cell specific). This enables UE 110 to receive data from both cells, and even to transmit to both cells, for example according to received uplink grants and power split according to network configuration. The data transmission and reception may be simultaneous or time-divided according to a pattern so that UE only transmits to one network node at a time. After the handover, another BWP switch (e.g. via DCI or RRC reconfiguration) may be used to make UE 110 operate according to a target cell specific BWP configuration (depicted as BWP 2 in the FIG. 3).

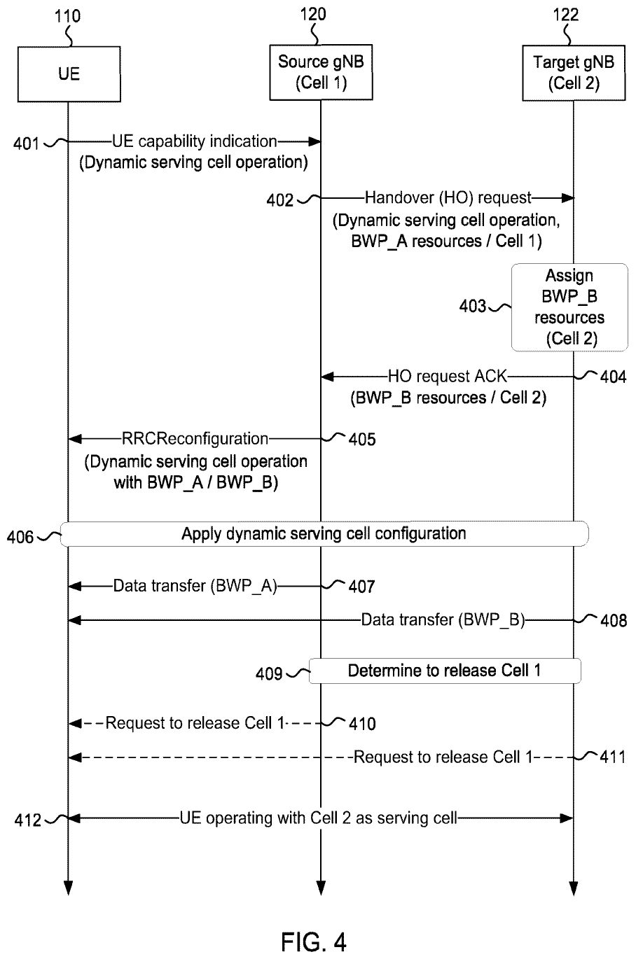

FIG. 4 illustrates an example of a signaling diagram for configuration of dynamic serving cell operation. The operations have been illustrated for UE 110, source gNB 120 of source cell 130 (Cell 1), and target gNB 122 of target cell 132 (Cell 2). Even though the operations have been described using gNBs as examples of network nodes, it is appreciated that similar functionality may be applied also for TRPs, or other applicable access nodes. In this example, UE 110 is initially operating under source cell 130 (serving cell) having a first identifier (ID=1). UE 110 is then handed over to target cell 132 (neighbour cell) having a second identifier (ID=2). Even though this operation has been described using handover as example, similar operation where UE operation is coordinated between two network nodes may be also applied.

At operation 401, UE 110 may transmit an indication its capability for dynamic serving cell operation, for example to source gNB 120. Dynamic serving cell (dynamic PCell) operation may refer to configuration of at least two different bandwidth parts for source and target cells such that UE 110 is able to communicate with both cells, for example source gNB 120 and target gNB 122, on a channel bandwidth comprising the configured bandwidth parts, at least during a handover from the source cell to the target cell. In other words, UE 110 may transmit, to the source gNB 120, an indication of a capability to transmit data to and receive data from the source gNB 120 and the target gNB 122 with different bandwidth parts and one channel bandwidth, for example simultaneously or in a time-divided manner, such as for example according to a pattern so that UE 110 only transmits to or receives from one network node at a time. UE 110 may further transmit an indication of its capability to communicate data with gNB 120 and gNB 122 using a single protocol stack.

UE 110 may further perform handover measurements. UE 110 may for example perform neighbour cell search and report detected cells to source gNB 120. Handover measurements may include monitoring received signal strength(s) of the source cell 130 and/or one or more candidate target cells. UE 110 may report results of the handover measurements to source gNB 120. A handover may be triggered, when UE 110 and/or source gNB 120 detects one or more conditions for triggering the handover to be met. It is noted that the handover may be performed according to any suitable handover scheme, for example as a normal (unconditional) handover, conditional handover, L1L2 mobility model, or the like. In case of any type of handover, target cell 130 may be configured as a DCell.

At operation 402, source gNB 120 may transmit a handover (HO) request to target gNB 122. The handover request may also be a different request that is used to request UE operation under both source and target cells, e.g. to provide UE simultaneous access to both source and target cell bandwidth parts. The handover request may comprise an indication of a first bandwidth part (BWP_A). The handover request, or in general the request to configure data communication with source gNB 120 and target gNB 122 with different bandwidth parts may be transmitted during handover preparation, for example at any time before reception of a handover request acknowledge message from target gNB 122. BWP_A may be configured for UE 110 for receiving/transmitting data to/from source gNB 120. BWP_A may be therefore associated with source cell 130 (Cell 1). BWP_A, and/or transmission resources thereof, may be determined by source gNB 120. The handover request may comprise a request for dynamic serving operation, e.g., a request to configure, for UE 110, data communication from source gNB 120 and target gNB 122 with different bandwidth parts during the handover. The request may further indicate that a single protocol stack is to be used by UE 110 for these communications. For example, the handover request may comprise a data field for signaling a type of handover indicative of dynamic serving operation. Additionally, in a disaggregated architecture the source cell and the target cell may be associated with the same distributed unit or different distributed unit (DU), which may be controlled by the same central unit (CU). In such a scenario, the handover request may be substituted by a different procedure between the CU and the DU(s) to setup and manage the dynamic cell operation.

The handover request may be included in or provided as one or more control messages. Source gNB 120 may transmit the handover request, in response to receiving the indication of the handover capability of UE 110 to simultaneously receive data from source and target gNBs with different bandwidth parts, or in general, the UE capability of dynamic serving cell operation. The handover request may comprise, or be interpreted by source gNB 120 as, a request for activating dynamic serving cell operation. During handover UE 110 may be connected to both source gNB 120 and target gNB 122. The handover may begin from the time when the handover is triggered, e.g. due to handover measurement(s) meeting handover threshold(s). The handover may end when source gNB 120 is released, e.g., when UE 110 terminates receiving data from source gNB 120.

At operation 403, target gNB 122 may assign a second bandwidth part (BWP_B), and/or transmission resources thereof, for transmission of data to UE 110 by target gNB 122 during the handover of UE 110 from source gNB 120 to target gNB 122. BWP_B may be associated with target cell 132 (Cell 2). BWP_B may be used during the handover for simultaneous reception of data by UE 110 with a single channel bandwidth comprising both BWP_A and BWP_B. It is however possible that target gNB 122 continues to use BWP_B also after completing the handover, e.g. after release of source gNB 120. Alternatively, or additionally, other transmission resources or bandwidth parts may be assigned to UE 110 when the handover has been completed. Target gNB 122 may determine BWP_B based on the indication of BWP_A received from source gNB 120. For example, target gNB 122 may determine BWP_B such that UE 110 is enabled to receive both BWP_A and BWP_B with a single receive bandwidth. BWP_A may be for example adjacent to BWP_B, or in general sufficiently close in the frequency spectrum such that receive bandwidth of UE 110 may be tuned to cover both bandwidth parts. Two BWPs may be adjacent, if there are no other BWPs between the adjacent BWPs. UE 110 may transmit an indication of its receive bandwidth to source gNB 120, for example within the UE capability indication of operation 401. Source gNB 120 may forward this indication to target gNB 130, for example within the handover request of operation 402.

At operation 404, target gNB 122 may transmit a configuration of the second bandwidth part (BWP_B) to source gNB 120. The configuration of BWP_B may be transmitted as part of a handover preparation confirmation, for example in a handover request acknowledgement (ACK) message. In general, an indication (e.g. identifier) of the second bandwidth part may be included in any suitable control message.

At operation 405, source gNB 120 may transmit to UE 110, configuration of the first bandwidth part (BWP_A) for UE 110 to receive data from source gNB 120 at least during the handover. Source gNB 120 may further transmit to UE 110, configuration of the second bandwidth part (BWP_B) for UE 110 to receive data from target gNB 122 at least during the handover. The configuration of BWP_A and/or the configuration of BWP_B may be included in a RRC reconfiguration message (RRCReconfiguration). In general, one or more reconfiguration messages, comprising the configurations of BWP_A and BWP_B, may be transmitted to UE 110. This enables configuration of dynamic serving cell operation for target cell 132.

At operation 406, UE 110, source gNB 120, and target gNB 122 may apply the dynamic serving cell configuration. For example, UE 110 may receive a channel bandwidth switch command or request causing the UE to tune its receive bandwidth to include both BWP_A and BWP_B and thus be able to receive data from both bandwidth parts. Hence, UE 110 is then enabled to receive data from source gNB 120 and ‘source’ gNB 122. Target gNB 122 may be also called a ‘source gNB’. Target gNB 122 may therefore also operate as a source gNB, for example by scheduling data for UE 110. Source gNB 120 and target (or ‘source’) gNB 122 may now configure transmission of data at BWP_A and BWP_B, respectively. The uplink power towards source gNB 120 and target/‘source’ gNB 122 may also be limited according to instructions given in operation 406.

At operation 407, data may be transferred between source gNB 120 and UE 110 at the first bandwidth part (BWP_A). UE 110 may therefore perform communication of data to source gNB 120 at BWP_A. For example, source gNB 120 may transmit data on BWP_A. The data may comprise downlink data, for example PDCCH data and/or PDSCH data. UE 110 may receive the data at BWP_A.

At operation 408, data may be transferred between target/‘source’ gNB 122 and UE 110 at the second bandwidth part (BWP_B). UE 110 may therefore perform communication of data to target gNB 122 and BWP_B. For example, target/‘source’ gNB 122 may transmit data on BWP_B. UE 110 may receive the data at BWP_B. The data may comprise downlink data, for example PDCCH data and/or PDSCH data. Source gNB 120 and target/‘source’ gNB 122 may share the same downlink data channel(s) (e.g. PDCCH and/or PDSCH) or the gNBs may be associated, e.g. configured to transmit, with different data channel(s). UE 110 may transmit, to source gNB 120 and/or target/‘source’ gNB 122, an indication of successful reception of data from target/‘source’ gNB 122 at BWP_B. Transmission of the indication of successful reception of data may be in response to detecting that the data has been successfully received, for example based on successful FEC decoding of the data. In general, the indication may be provided in response to successful establishment of communication with the target gNB 122 at BWP_B.

Operations 407 and 408 may occur simultaneously. UE 110 may therefore simultaneously transmit to and receive data from source gNB 120 and target gNB 122 during the dynamic cell operation as per operations 406, 407 and 408. UE 110 may use a (receive) bandwidth comprising both BWP_A and BWP_B when receiving the data. For example, UE 110 may receive data from both gNBs on the same RF bandwidth (channel bandwidth). However, decoding of the data received using this bandwidth may be done separately, for example based on different decoding parameters associated with the two bandwidth parts. At operations 407 and 408, UE 110 may also communicate with the source and target gNBs also in the uplink direction. UE 110 may for example simultaneously transmit data to source gNB 120 at BWP_A and to target gNB 122 at BWP_B, or transmit data first to source gNB 120 at BWP_A and only then to target gNB 122 at BWP_B.

At operation 409, source gNB 120 and/or target gNB 122 may determine to release the source cell (Cell 1). The network may therefore decide to start using only Cell 2 for transmitting data to UE 110. This decision may be communicated to UE 110 by signalling the change from either Cell 1 or Cell 2, or both cells (cf. operations 410 and 411).

At operation 410, the source gNB 120 may transmit a request to release the source cell (source gNB 120). The request to release the source cell may be transmitted in response to receiving the indication of successful reception of data by UE 110 from target gNB 122 at BWP_B. This operation may be performed as an alternative, or in addition to operation 411.

At operation 411, the target gNB 120 may transmit a request to release the source cell (source gNB 120). Operation 411 may be performed as an alternative, or in addition, to operation 410. The request to release the source cell may be transmitted in response to receiving the indication of successful reception of data by UE 110 from target gNB 122. The indication of successful reception of data by UE 110 may be received directly from UE 110, or via source gNB 120. In one example, source gNB 120 may therefore transmit, to target gNB 122, an indication to release the source gNB 120. Source gNB 120 may perform this response to receiving from UE 110, the indication of successful reception of data by UE 110 from target gNB 122 at BWP_B.

At operation 412, UE 110 may operate with Cell 2 as the serving cell. UE 110 may terminate reception of data from source gNB 120. Termination of the data reception from source gNB 120 may be in response to receiving, from source gNB 120 and/or target gNB 122, the request to release Cell 1 (source gNB 120). UE 110 may however continue reception of data from target gNB 120 at BWP_B. When receiving data from target gNB 122 (and not source gNB 120), UE 110 may use another (receive) bandwidth, which comprises BWP_B but does not comprise BWP_A. UE 110 may however store Cell 1 as a candidate neighbour cell for subsequent handovers.

Even though source gNB 120 and target gNB 122 have been illustrated as separate devices, it is appreciated that various different implementations may be applied. For example, source gNB 120 and target gNB 122 may be associated with the same access network node or different access network nodes, for example in case of a disaggregated network architecture. For example, source and target gNBs may refer to same or different gNB-DUs being associated with the same gNB (gNB-CU). Alternatively, source gNB 120 and target gNB 122 may be the same gNB. Example embodiments of the present disclosure may be therefore applied in any of inter-DU, intra-DU, or inter-gNB scenarios.

The example of FIG. 4 improves the handover by enabling simultaneous data reception by UE 110 using a single channel bandwidth. Compared to DAPS, the DCell may be substantially instantaneously switched to operate as PCell without the overhead caused by the requirement of a dual active protocol stack which duplicates the entire source radio configuration and protocol stack configuration at the target as well which may be challenging from the UE software and hardware implementation point of view. The introduction of the DCell greatly simplifies UE implementation and only requires a single protocol stack, which is used towards both source gNB 120 and target gNB 122. Compared to conditional handover, the activation time requirements of the DCell are subsumed into the conditional handover preparation phase, but conditional handover still suffers from the deficiency that UE 110 is unable to receive data from the target cell 132 until the execution condition (e.g. A3) is met. Contrary to conditional handover, the example embodiments of the present disclosure enables simultaneous reception of data from the DCell. Compared to bandwidth adaptation, the DCell concept provides a smooth transition between handover and dual cell (source and target simultaneous reception) by smartly utilizing the bandwidth part principles. As such the active bandwidth part may be utilized by the UE across the PCell and the DCell allowing a “carrier aggregation of sorts”, while simultaneously allowing an instantaneous handover from PCell to DCell and still allowing dual cell reception on the corresponding bandwidth parts.

The following non-limiting example relates to a scenario where UE 110 is camped on a carrier in a lower frequency range (e.g. LTE or NR FR1) and UE 110 is capable of performing intra-frequency or inter-frequency measurements without measurement gaps. It is assumed that BWP switch is used in order to facilitate handover between two cells. Initially, UE 110 performs normal neighbour cell search and reports detected cells to the network. Based on the reported cells (or even before) the network may configure UE 110 with a neighbour cell specific BWP. Once UE 110 has reported the neighbour cell(s), the network may activate the BWP which includes the neighbour cell BWP. UE 110 may then start to (try to) receive the downlink from the neighbour BWP. At successful reception from the neighbour BWP, UE 110 may indicate to the source cell 130 that downlink can be successfully received from the neighbour cell (e.g. target cell 132). The network may then send a BWP switch command to UE 110 to change the BWP to a BWP which only includes downlink BWP from the neighbour cell. Hereafter, UE may only receive downlink from the neighbour cell.

Assuming the above scenario, it is possible to estimate the potential handover delay in terms of cell change interrupt, which a cell change using BWP switch could facilitate. Using the handover delay model presented above, the interruption time may slightly differ depending on the type of handover, but it generally contains following delays: when intra-frequency or inter-frequency handover is commanded, the interruption time is less than Tᵢₙₜₑᵣᵣᵤₚₜ, where

$${T}_{i n t e r r u p t} = {T}_{s e a r c h} + {T}_{IU} + {T}_{p r o c e s s i n g} + {T}_{Δ} + {T}_{m a r g i n} ( ms ) .$$

Similar to conditional handover, term T_{search} would not exist in this example as UE 110 would be synchronised to target cell 132, because UE 110 would be attempting to decode downlink from target cell 132. Hence, T_{search}=0 ms. Also, T_{Δ} is not present as the UE may be assumed to be capable of decoding data from target cell 132 as otherwise BWP switch may not be possible. Hence, T_{Δ}=0 ms. T_{processing} may be significantly reduced, if not completely removed. At least it may be assumed that UE 110 has enough information to receive and decode data on lower layers while some upper layer delay due to cell switch may still occur. T_{margin} may be assumed to be zero since UE 110 is capable of receiving data from the neighbour cell BWP. Hence, T_{margin}=0 ms. T_{IU} may be reduced with smart implementation on network side. However, in the worst case T_{IU} is unchanged and depends on the network PRACH allocation. This means that it is realistically possible to reduce the interrupt time Tᵢₙₜₑᵣᵣᵤₚₜ to

$${T}_{interrupt} = {T}_{IU} + {T}_{p r o c e s s i n g} ( ms ) .$$

T_{processing} may be assumed to be zero since UE 110 receives downlink from the neighbour BWP. However, a BWP switch delay may need to be added:

$${T}_{i n t e r r u p t} = {T}_{IU} + {T}_{B W P S w i t c h D e l a y} ( ms ) ,$$

where the BWP switch delay may be for example correspond to 1 to 18 slots of 0.125 to 1 ms, according to the following table:

| | |
|---|---|
| NR Slot | |
| length | BWP switch delay T_{BWPswitchDelay} (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
May depend on UE capability.
Note 2:
If the BWP switch involves changing of SCS, the BWP switch delay may be determined by the smaller subcarrier spacing (SCS) between the SCS before BWP switch and the SCS after BWP switch.

The example embodiments of the present disclosure may be applied at least in the following two scenarios:
1) To actuate efficient load balancing in a cell with a given cell bandwidth and provide UEs with different BWP capabilities access to the cell. This ensures that UEs with limited BWP capability may be configured to access the network in a cell compatible with UE's BWP capabilities. This may be done either at a PCell or a DCell. UEs capable of the entire cell bandwidth may be configured to access the network wherever there is free capacity available.
2) To provide simultaneous access to a UE (with required BWP capability) to both PCell and DCell for control and/or user-plane. Since the example embodiments are applicable to a single DU and its cells, the control plane signaling associated with configuring the dynamic serving cell operation is very simple with respect to both network-internal signaling as well as network-UE signaling.

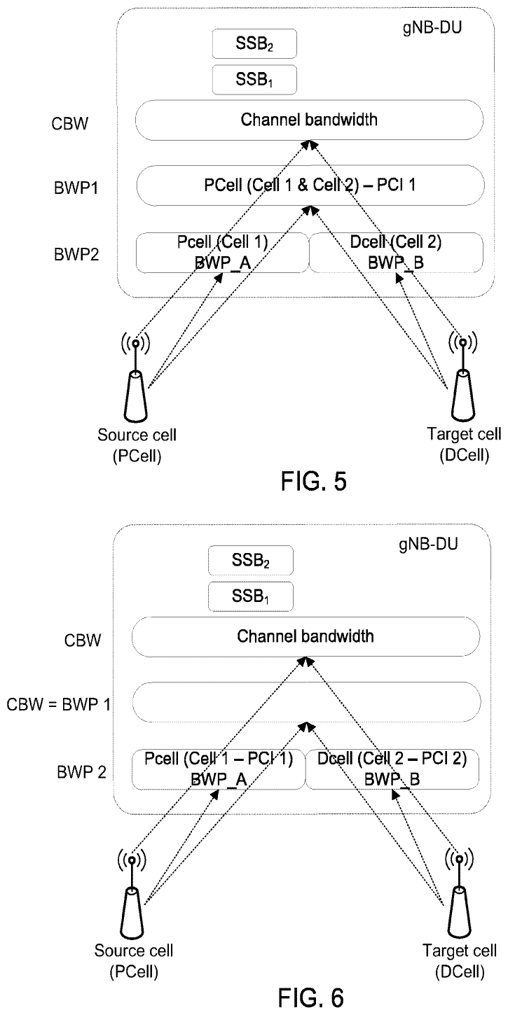

Two suitable implementation alternatives for these scenarios are described with reference to FIG. 5 and FIG. 6.

FIG. 5 illustrates an example of dynamic serving cell operation in an intra-cell scenario. In particular, this example may relate to an intra-gNB-DU, intra-frequency, and intra-cell (single PCI) handover with dual-BWP. Both source cell 130 (Cell 1) and target cell 132 (Cell 2) may be associated with the same cell identifier (PCI 1). The cells may therefore share the same cell identifier. A cell with a given channel bandwidth (CBW) may be sliced to two cells based on different BWPs (BWP_A, BWP_B). These may be called PCell and DCell. PCell and DCell may be configured to transmit their own SSBs. UE 110 may access one or more BWPs. PCell and DCell may be used for simultaneous data transmission by UE 110. DCell BWP may be indicated in PCell configuration. Hence a handover between PCell and DCell may be actuated using for example a simple MAC CE command. Serving cell change may be based on any suitable handover scheme (e.g. unconditional handover, conditional handover, L1/L2 centric inter-cell change). In any case, DCell configuration may be supplied to UE 110 together with PCell configuration. This scenario enables UE 110 to avoid using RACH for DCell access. Downlink data channels (e.g. PDCCH/PDSCH) may be common for both PCell and DCell. Source gNB 120 and target gNB 122 may therefore share same downlink data channels for transmission of the data to UE 110.

FIG. 6 illustrates an example of dynamic serving cell operation in an inter-cell scenario. In particular, this example may relate to an intra-gNB-DU, intra-frequency, inter-cell handover with dual-BWP. A cell with a given channel bandwidth may be again sliced to two cells (PCell, DCell) based on different BWPs. PCell and DCell may be associated with different cell identifiers. For example, PCell may have a first cell identifier (PCI 1) and DCell may have a second cell identifier (PCI 2). Again, PCell and DCell may be configured to transmit different SSBs. PCell and DCell may be also used for simultaneous or time-divided data transmission by UE 110. DCell BWP and PCI may be indicated as a delta configuration of the PCell configuration, wherein a delta configuration is configuration that refers to an existing configuration at the UE so that only the configuration parts that change are transmitted, which could for example mean that for a ULE configuration consisting of 1000 configuration parameters and one configuration parameter needing to be changed, only information necessary to indicate changes to the one configuration parameter that needs changes is signalled, which can reduce signalling overhead. A delta configuration may therefore comprise a set of parameters that are incremental to an existing configuration at UE 110. Hence a handover between PCell and DCell may be actuated for example using a simple MAC CE command. Serving cell change may be based on any suitable handover scheme (e.g. unconditional handover, conditional handover, L1/L2 centric inter-cell change). In any case, DCell configuration may be supplied to UE 110 together with Pcell configuration. Downlink data channels (e.g. PDCCH and/or PDSCH) may be dedicated for PCell and DCell. Hence, source gNB 120 and target gNB 122 may be associated with different downlink channels for transmission of the data to UE 110.

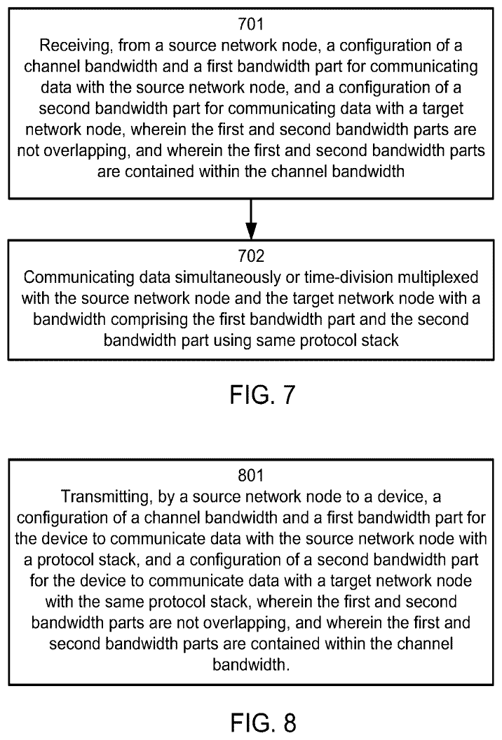

FIG. 7 illustrates an example of a method for performing handover.

At 701, the method may comprise receiving, from a source network node, a configuration of a channel bandwidth and a first bandwidth part for communicating data with the source network node, and a configuration of a second bandwidth part for communicating data with a target network node, wherein the first and second bandwidth parts are not overlapping, and wherein the first and second bandwidth parts are contained within the channel bandwidth.

At 702, the method may comprise communicating data simultaneously or time-division multiplexed with the source network node and the target network node with a bandwidth comprising the first bandwidth part and the second bandwidth part using same protocol stack.

FIG. 8 illustrates an example of a method for configuring handover at a source network node.

At 801, the method may comprise transmitting, by a source network node to a device, a configuration of a channel bandwidth and a first bandwidth part for the device to communicate data with the source network node with a protocol stack, and a configuration of a second bandwidth part for the device to communicate data with a target network node with the same protocol stack, wherein the first and second bandwidth parts are not overlapping, and wherein the first and second bandwidth parts are contained within the channel bandwidth.

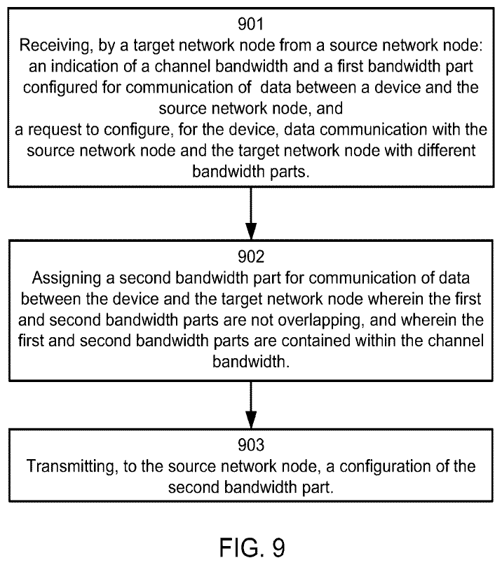

FIG. 9 illustrates an example of a method for configuring a handover at a target network node.

At 901, the method may comprise receiving, by a target network node from a source network node: an indication of a channel bandwidth and a first bandwidth part configured for communication of data between a device and the source network node, and a request to configure, for the device, data communication with the source network node and the target network node with different bandwidth parts.

At 902, the method may comprise assigning a second bandwidth part for communication of data between the device and the target network node wherein the first and second bandwidth parts are not overlapping, and wherein the first and second bandwidth parts are contained within the channel bandwidth.

At 903, the method may comprise transmitting, to the source network node, a configuration of the second bandwidth part.

Further features of the methods directly result from the functionalities and parameters of the UE 110, source gNB 120, and/or target gNB 122, or in general apparatus 200, as described in the appended claims and throughout the specification, and are therefore not repeated here. Different variations of the methods may be also applied, as described in connection with the various example embodiments.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable)(i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1.-50. (canceled)

51. An apparatus, comprising:
one or more processors, and
memory storing instructions that, when executed by the one or more processors, cause the apparatus to:
receive, from a source network node, a configuration of a channel bandwidth and a first bandwidth part for communicating data with the source network node, and a configuration of a second bandwidth part for communicating data with a target network node, wherein the first and second bandwidth parts are not overlapping, and wherein the first and second bandwidth parts are contained within the channel bandwidth; and
communicate data simultaneously or time-division multiplexed with the source network node and the target network node with a bandwidth comprising the first bandwidth part and the second bandwidth part using same protocol stack.

52. The apparatus according to claim 51, wherein the instructions, when executed by the one or more processors, further cause the apparatus to:
terminate communication of data with the source network node configured with the first bandwidth part; and
continue communication of data with the target network node with another bandwidth comprising the second bandwidth part but not comprising the first bandwidth part.

53. The apparatus according to claim 51, wherein the instructions, when executed by the one or more processors, further cause the apparatus to:
transmit, to the source network node, an indication of a capability to communicate data with the source network node and the target network nodes with different bandwidth parts.

54. The apparatus according to claim 51, wherein the configuration of the first bandwidth part and/or the configuration of the second bandwidth part is received in a radio resource control reconfiguration message.

55. The apparatus according to claim 51, wherein the instructions, when executed by the one or more processors, further cause the apparatus to:
transmit, to the source network node, an indication of successful establishment of communication with the target network node at the second bandwidth part.

56. The apparatus according to claim 51, wherein the instructions, when executed by the one or more processors, further cause the apparatus to:
terminate the communication of data with the source network node, in response to receiving, from the source network node and/or the target network node, a request to release the source network node.

57. The apparatus according to claim 51, wherein the first bandwidth part is adjacent to the second bandwidth part.

58. An apparatus, comprising:
one or more processors, and
memory storing instructions that, when executed by the one or more processors, cause the apparatus to:
transmit, by a source network node to a device, a configuration of a channel bandwidth and a first bandwidth part for the device to communicate data with the source network node with a protocol stack, and a configuration of a second bandwidth part for the device to communicate data with a target network node with the same protocol stack, wherein the first and second bandwidth parts are not overlapping, and wherein the first and second bandwidth parts are contained within the channel bandwidth.

59. The apparatus according to claim 58, wherein the instructions, when executed by the one or more processors, further cause the apparatus to:
transmit, to the target network node:
an indication of the first bandwidth part, and
a request to configure, for the device, data communication with the source network node and the target network node with different bandwidth parts.

60. The apparatus according to claim 58, wherein the instructions, when executed by the one or more processors, further cause the apparatus to:
transmit the indication of the first bandwidth part and the request to configure data communication with the source network node and the target network node with different bandwidth parts, in response to receiving an indication of a capability of the device to communicate data with the source network node and the target network node with different bandwidth parts.

61. The apparatus according to claim 58, wherein the instructions, when executed by the one or more processors, further cause the apparatus to:
receive the configuration of the second bandwidth part from the target network node.

62. The apparatus according to claim 58, wherein the configuration of the first bandwidth part and/or the configuration of the second bandwidth part is transmitted in a radio resource control reconfiguration message.

63. The apparatus according to claim 58, wherein the instructions, when executed by the one or more processors, further cause the apparatus to:
transmit, to the device, a request to release the source network node, in response to receiving, from the device, an indication of successful establishment of communication by the device with the target network node at the second bandwidth part, or
transmit, to the target network node, an indication to release the source network node, in response to receiving, from the device, the indication of successful establishment of communication by the device with the target network node at the second bandwidth part.

64. The apparatus according to claim 58, wherein the first bandwidth part is adjacent to the second bandwidth part.

65. The apparatus according to claim 58, wherein the source network node and the target network node are associated with same cell identifier.

66. The apparatus according to claim 58, wherein the instructions, when executed by the one or more processors, further cause the apparatus to:
transmit, to the device, a medium access control control element command configured to actuate a handover of the device from the source network node to the target network node, wherein the first bandwidth part is configured for communication of data between the device and the source network node at least during the handover, and wherein the second bandwidth part is configured for communication of data between the device and the target network node at least during the handover.

67. The apparatus according to claim 58, wherein the source network node and the target network node are associated with the same access network node or different access network nodes in a disaggregated network architecture.

68. An apparatus, comprising:
one or more processors, and
memory storing instructions that, when executed by the one or more processors, cause the apparatus to:
receive, by a target network node from a source network node:
an indication of a channel bandwidth and a first bandwidth part configured for communication of data between a device and the source network node, and
a request to configure, for the device, data communication with the source network node and the target network node with different bandwidth parts;
assign a second bandwidth part for communication of data between the device and the target network node wherein the first and second bandwidth parts are not overlapping, and
wherein the first and second bandwidth parts are contained within the channel bandwidth; and
transmit, to the source network node, a configuration of the second bandwidth part.

69. The apparatus according to claim 68, wherein the instructions, when executed by the one or more processors, further cause the apparatus to:
communicate data with the device using the second bandwidth part.

70. The apparatus according to claim 68, wherein the indication of the first bandwidth part and the request to configure data communication with the source network node and the target network node with different bandwidth parts is included in a handover request, and/or wherein the configuration of the second bandwidth part is included in a handover request acknowledgement message.
